(19) United States
(12) Patent Application Publication
(10) Pub. No.: US 2009/0027907 A1
(43) Pub. Date: Jan. 29, 2009

(54) LAMP WITH REFLECTIVE COATING

(75) Inventors: Benno Spinger, Aachen (DE); Lukas Kupper, Aachen (DE); Josephus Christiaan Maria Hendricx, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,908

(22) PCT Filed: Aug. 15, 2005
(86) PCT No.: PCT/IB2005/052682

§ 371 Date: Feb. 19, 2007

(30) Foreign Application Priority Data
Aug. 26, 2004 (EP) 04104097.3

(51) Int. Cl. F21V 1/00; H01J 61/35

(52) U.S. Cl. 362/509; 313/635

(57) ABSTRACT

The invention relates to a lamp (10) and a vehicle headlight. The lamp (10) comprises a discharge vessel (16) with electrodes (20) arranged at a distance for creating an arc discharge. The envelope (22) has cylindrical shape with a cylinder wall extending straight in longitudinal direction. A reflective barrier (28) is arranged at least partly surrounding said discharge vessel for reflecting light emitted from the arc discharge. To obtain an optimally focused reflection, the discharge vessel (16) is configured such that the arc (50) is essentially straight. The reflective barrier (28) also extends straight in longitudinal direction.

The present invention relates to a lamp and a vehicle headlight.

Specifically, a lamp of the discharge type comprises

a discharge vessel with electrodes arranged at a distance in a longitudinal direction for creating an arc discharge,

and a reflective barrier at least partly surrounding said discharge vessel for reflecting light emitted from said arc discharge, where at least a part of said reflective barrier is arranged in said longitudinal direction between said electrodes.

A lamp of this type is known from U.S. Pat. No. 6,445,129. Here, a gaseous-discharge lamp, in particular for motor vehicle headlamps is described. The discharge vessel is made of glass or the like. Two electrodes extend into the discharge vessel and form an arc gap. The discharge vessel is shown to have elliptical shape in longitudinal section, and the discharge formed between the electrodes has arcuate shape. A coating applied on the inside or outside of the discharge vessel may have reflecting properties and can be used as a light reflector. The metallic coating extends in longitudinal direction over the central part of the discharge vessel, and in circumferential direction extends over the lower half thereof. It is stated that by using a metallic coating having the right reflecting properties, the light that would otherwise be lost may be used to illuminate the street.

However, a lamp of the described type is not very well suited for use in a complex shape reflector because light reflected at the reflective coating may lead to the light emitting part of the lamp no longer being optimally focused.

It is therefore the object of the invention to propose a lamp and a vehicle headlight where improved use is made of the emitted light without loosing focus.

This object is solved by a lamp according to claim 1 and a vehicle headlight according to claim 10. Dependent claims relate to preferred embodiments.

The invention is based on the observation that two main factors contribute to degradation of focus. On one hand, the shape of the reflective barrier in the prior art has not been chosen optimally. On the other hand, the arcuate shape of the discharge, when reflected, leads to a mirror image with an inverse arc, which may produce a ghost image.

In the lamp according to the invention, the discharge vessel is configured such that the arc discharge therein is essentially straight. Also, the reflective barrier, extends straight in longitudinal direction.

The lamp according to the invention makes good use of the light emitted by the discharge, because a part that would usually be shielded is reflected. At the same time, good focus is maintained.

This shape of the reflective barrier, together with the essentially straight arc discharge, leads to a well-defined mirror image of the discharge when reflected. The reflective barrier is arranged in longitudinal direction at least on a central part of the cylinder, and may extend up to the electrodes, and also beyond, to reflect the light from the arc discharge along its whole length in well-defined manner. It is, however, preferred to arrange the barrier such that it does not quite extend up to the electrodes, thus covering less than the electrode distance.

To achieve an essentially straight arc, the discharge vessel may have a specially chosen inner diameter, configured such that the arc discharge is confined by the cylinder wall such that its lateral deviation is limited. While the glass material mentioned in U.S. Pat. No. 6,445,129 will generally not exhibit the necessary heat resistance to confine the arc, this may be achieved by very high temperature resistant translucent or transparent ceramics material, e.g. Al₂O₃. A lamp of the type with a ceramic cylindrical discharge vessel is described in U.S. Pat. No. 6,404,129, which is incorporated herein by reference. If the inner diameter of the cylindrical discharge vessel is denoted Di and the distance between the electrodes is denoted EA, it is preferred to choose dimensions such that Di≦2 mm and EA/Di<5. This small internal diameter, in relation to the electrode spacing, leads to the discharge arc being confined by the walls such that its shape is straightened, and preferably extends essentially straight between the electrodes along the central cylinder axis.

By confining the arc to limit deviation from the central axis the loss of focus caused by the completely uninhibited arcuate shape known from the prior art is minimized. In the present context, the term “essentially straight” referring to the arc discharge refers to an arc (as viewed from the side of a horizontally oriented discharge vessel) which exhibits a minimum of curvature, if any at all. To measure curvature of an arc, it is here proposed to consider a central curved line, following in longitudinal direction the maximum luminance of the (luminance distribution of the) arc. On this curve, we consider three points positioned at 5%, 95% and 50% of the electrode distance. Curvature of the arc may now be measured as the distance of the last point from a straight line through the first two. The curvature of the arc, measured in this way should be less than 0.1 mm, and preferably even less than 0.07 mm.

Generally, the reflective barrier may be configured in many different ways. It should, however, be considered that the usefulness of the reflected light in the final beam pattern decreases with increasing distance of the barrier from the arc. Therefore, two preferred embodiments are proposed here.

On one hand, it is possible to provide the reflective barrier as a coating on the outside of the inner envelope. In this case, the outside surface of the inner envelope comprises a wall extending straight in longitudinal direction. The reflective coating is arranged on the outer surface of the wall. This provides for a useful reflection pattern, because of a very small distance from the arc discharge. However, the coating material needs to be resistant to the high temperatures of the discharge vessel.

While it is generally preferred for the wall of the discharge vessel to be of at least substantially circular shape in cross-section, this may lead to a loss of focus if the arc discharge is not arranged in the center of the circle. Even a straight arc will in many cases not be positioned exactly between electrode centers, but may, due to convection, be shifted in upward direction from the center. To restore optimal focus, the wall may comprise at its outside surface, at least in the area of the coating, a special structure. This structure should provide reflection focused on the actual location of the arc discharge, which may be off-center. The structure may comprise a plurality of specially directed surfaces, arranged to reflect light from the location of the arc discharge back into the same location. The specially directed surfaces may be plane.

On the other hand, the reflective barrier may be provided on the inside of an outer envelope, which is arranged around the discharge vessel. Generally, an outer envelope is already used to protect the discharge vessel, mainly against oxidation, and to even temperature distribution. The outer envelope will advantageously include a wall where the inner surface extends straight in longitudinal direction. The reflective barrier, which is provided as a coating on this inside surface, is still close enough to the arc discharge to retain a useful beam pattern. The coating material still needs to be high temperature resistant, although the temperature on the outer envelope will not be as high as that of the discharge vessel.

Here again, the arc may be positioned off-center within the discharge vessel. The inside surface of the outer envelope preferably has circular cross section. To retain focus, the discharge vessel is arranged within the outer envelope in such a manner that the arc discharge is arranged in the center. Thus, the effect of an off-center arc within the discharge vessel may be countered by arranging the discharge vessel off-center within the outer envelope in opposite direction.

According to a development of the invention, the coating is non-conductive or has an insulating covering, which may be provided as a further coating of non-conducting material. This reduces the risk of the coating becoming part of the current path.

A further development of the invention relates to the part of the envelope covered by the reflective barrier in circumferential direction. It is preferred for the barrier to extend less than 180° around the cylinder, most preferably 140-165°. In a pre-ferred embodiment, the barrier extends such that it leaves light emitted in an angle of 195° (seen in cross-section) unshaded, such that a full 195° can be used for illumination without half-shade effects. This value has been shown to be advantageous if the lamp is to be used within a headlight reflector, preferably a complex shape reflector of a vehicle.

In the following, preferred embodiments of the invention will be explained with reference to the drawings, where

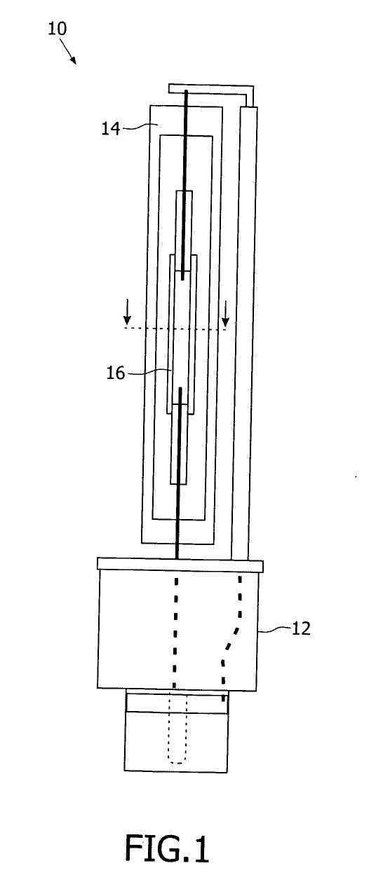

FIG. 1 shows a side view of a lamp;

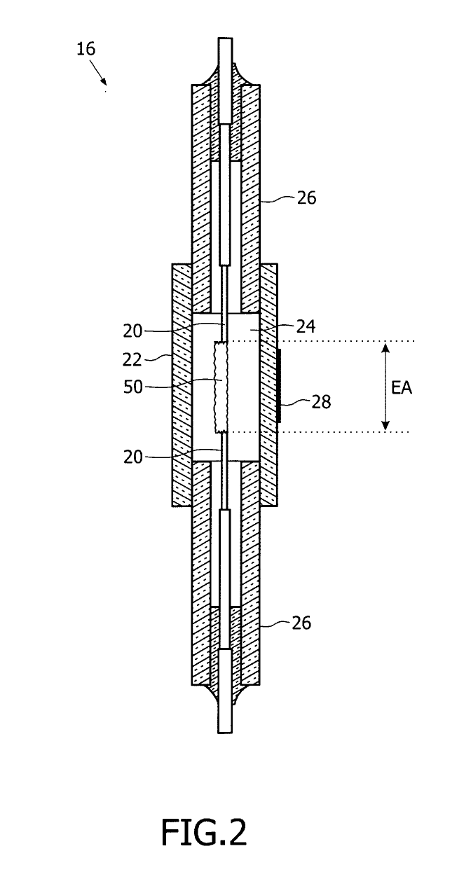

FIG. 2 shows a longitudinal sectional view of the discharge vessel according to a first embodiment of the invention of the lamp from FIG. 1;

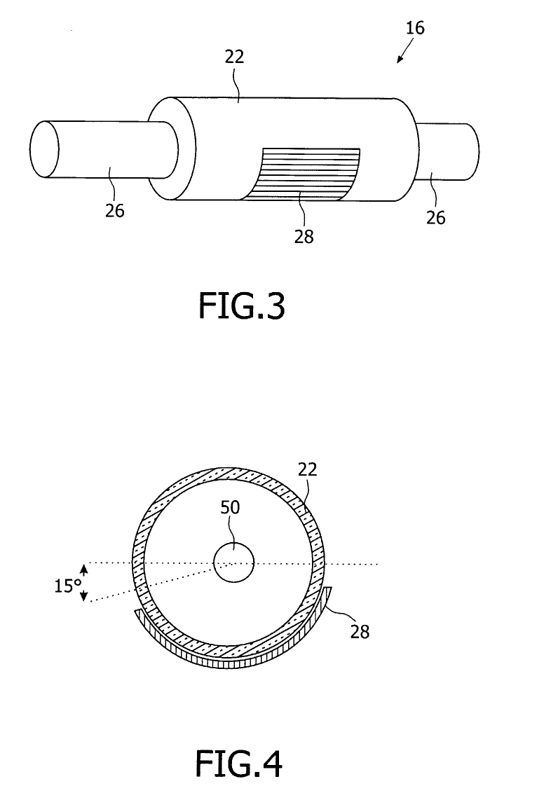

FIG. 3 shows a perspective view of the discharge vessel from FIG. 2;

FIG. 4 shows a cross-sectional view of the discharge vessel from FIG. 2;

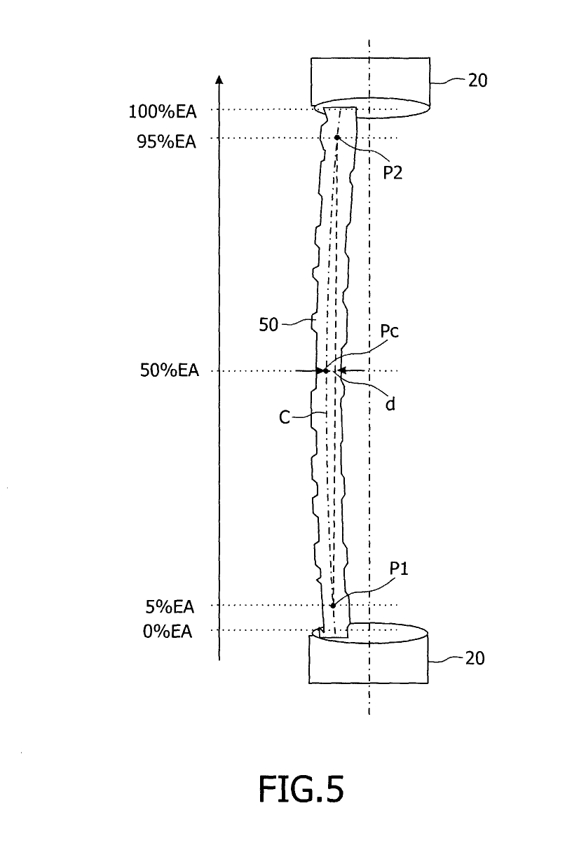

FIG. 5 shows a side view of an arc discharge;

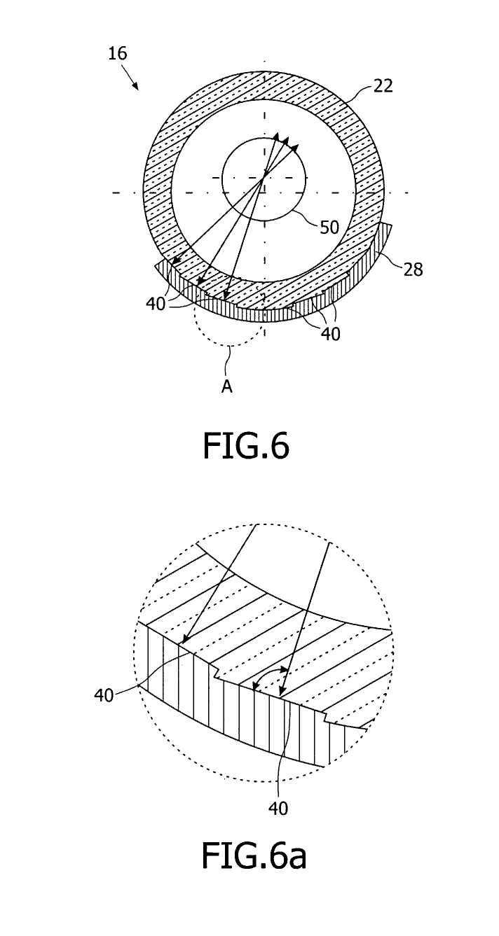

FIG. 6 shows a cross-sectional view of a discharge vessel according to a second embodiment of the invention;

FIG. 6a shows an enlarged view of the circle A in FIG. 6;

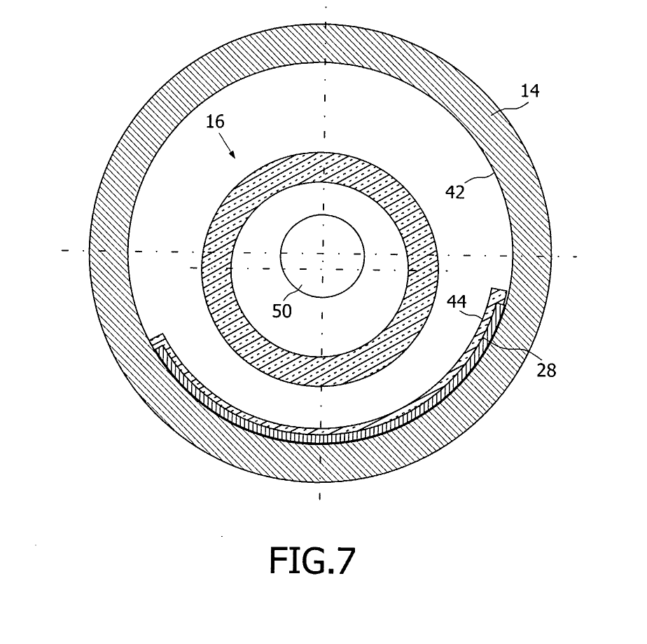

FIG. 7 shows a cross-sectioned view of a lamp according to a third embodiment of the invention;

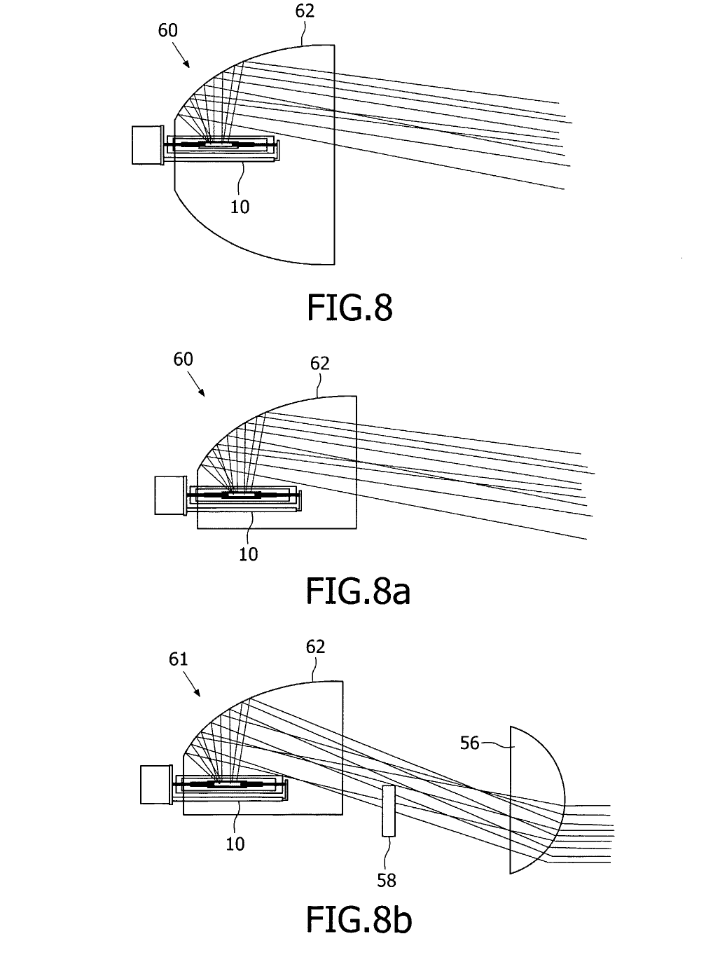

FIG. 8, 8a, 8b show symbolic representations of light beams within vehicle headlamps.

FIG. 1 shows a metal halide lamp 10 comprising a socket 12, an outer cylinder 14 and a discharge vessel 16 within the outer cylinder 14. The outer cylinder 14 is made out of quartz material. The shape of the outer cylinder 14 is generally cylindrical with circular cross-section. The inside of outer cylinder 14 is filled with gas.

The discharge vessel 16 according to a first embodiment is shown in the sectional view in FIG. 2 in greater detail. The discharge vessel 16 has a ceramic wall 22 of cylindrical shape, which encloses a discharge space 24. Tips of electrodes 20 project into the discharge space 24 and are arranged opposite each other at a distance EA. The discharge vessel has an internal diameter Di. The discharge vessel 16 is closed off at both ends by ceramic plugs 26.

This type of lamp is generally known, e.g. from U.S. Pat. No. 6,404,129. Therefore, further details of the lamp itself, such as parameters of material, operation, gas filling of the discharge space 24 and others will not be further discussed here.

It is a special feature of discharge vessel 16 that the internal diameter Di is quite small, e.g. only 1.2 mm or 1.3 mm. The distance EA between the electrode tips 20 is 3, 4 or 5 mm, so that the ratio EA/Di is 2.5 or 3.07 but at most 4.17. Because of this, the arc between electrodes 20 will be strictly confined by walls 22 and extend essentially straight between electrode tips 20.

The exact shape and position of the arc depends on a plurality of parameters like e.g. the pressure within discharge vessel 16 and the type of gas filling and salts added. The “essentially straight” arcs according to the invention may still show a very small curvature. FIG. 5 illustrates how curvature of an arc 50 may be measured.

The arc 50 is regarded in side view in horizontal position of the lamp. Of course, the arc discharge 50 will not exhibit sharp edges, so the luminance distribution is considered.

A central curved line C is defined along the length of the arc 50 which corresponds to the maximum luminance. On this curve C, a first point P1 is defined at 5% of the distance EA between the electrodes, and a second point P2 is defined at 95% of EA. A central point Pc is defined as 50%. A distance of point Pc from the line through P1, P2 is defined as a distance d which is a measure of arc curvature.

It should be noted, that curvature is not defined as the distance of point Pc from the central axis of the electrodes 20. This is due to the fact, that in many cases the arc 50 will not extend from the electrode centers, but—although extending essentially straight—be shifted upward.

Back now in FIG. 2, the cylindrical central portion 22 of the discharge vessel has an external coating 28. Coating 28 has reflecting properties, such that it reflects light emitted from the arc discharge. As can be seen in FIGS. 2-4 the coating 28 extends along the cylindrical wall 22, so that the central part of the discharge vessel with the center between the electrodes 20 is covered. The coating 28 covers less than the distance EA between the electrodes 20. The reduced length of the coating 28 serves to reduce the size of the mirror image generated in longitudinal direction. In cases where the length of the minor image is not important it is also possible to cover the whole length of the space between electrodes 20, or even beyond, up to the whole length of the cylindrical wall 22.

In circumferential direction, the coating extends around the lower half of the discharge vessel 16 in FIG. 3, and more precisely, as shown in FIG. 4, covers an area extending over less than 165°, in the lower half of the cylinder circumference.

FIG. 4 also illustrates why, with the object of providing illumination in an area extending over 195°, the coating 128 covers less than 165°. The reason is that arc 50 is not concentrated in a single point in cross-section, but extends over a certain area. In order not to produce half-shading effects within the desired illumination area of 195°, coating 28 is accordingly smaller.

The combination of the (almost) straight arc, positioned in or close to the longitudinal central axis of the cylinder of discharge vessel 16 and the cylindrical shape of walls 22 leads to the effect that light emitted from the arc discharge in the shielded (<165°) direction is reflected back (almost) exactly into the arc. Thus, the light emitted from the discharge vessel 16 altogether is strongly focused.

This property can advantageously be employed when using lamp 20 in a vehicle headlight. The lamp described above can advantageously be used in vehicle headlights of both reflector and projection type.

FIG. 8 shows in symbolic cross-sectional view a reflector type vehicle headlight 60 comprising a reflector 62 and a lamp 10 of the above described type arranged within the reflector 62. Reflector 62 is a complex shape reflector, i.e. the reflecting inner surface has been designed by calculating the orientation of a large number of surface elements in order to achieve a desired lighting output pattern.

Here, primary light is emitted from the arc in the useful 195° direction directly. On the other hand a secondary light portion emitted into the coating-covered directions is reflected back into the arc, and thus into the useful 195° direction. In this way, good use is made of the light emitted. Also the output pattern may include a strong light/dark cutoff.

Since the lower half of lamp 10 is shielded, there is no need to employ a complete, generally symmetrical reflector 62 as shown in FIG. 8. Instead, the lower part of the reflector may be omitted as shown with reflector 64 in FIG. 8a. In a reflector type headlamp, it is very important to have a good focus of the light emitted, in order to produce a desired output pattern. Consequently, the lamp 10 here would advantageously have a coating 28 extending only partly between the electrodes as shown in FIG. 2 to limit the axial length of the reflected arc. Also, the coating would extend less than 165° in circumferential direction.

FIG. 8b shows lamp 10 employed in a projector type vehicle headlamp 61. Here, the desired output pattern, including a light/dark cutoff is achieved by means of a glare shield 58.

The reflector 62 is of essentially elliptical shape. A lens 56 serves to project the light onto the street. In a projection type headlamp as shown, the coating 28 could extend further in longitudinal direction, and also the exact value of an unshielded 195° area in circumferential direction is not critical here, because light/dark cutoff is achieved in a different way as compared to reflector type headlamps.

The coating 28 applied on the outer surface of ceramic wall 22 of a discharge vessel 16 must be temperature resistant for the operating temperature of the lamp. A possible reflective coating would comprise several layers of SiO₂ in a configuration with reflective properties. In a preferred embodiment, 30 layers of SiO₂ and ZrO₂ or alternatively of SiO₂ and Ta₂O₅ are provided, which gives a reflective coating temperature resistant up to 1275° C. The number of layers and their thickness depends on the desired reflection coefficient for the different wavelengths.

The given materials are non-conductive, which is preferred to reduce the risk of voltage breakdown outside of the discharge vessel.

FIG. 6 shows a second embodiment of a discharge vessel 16, which is a modification of the first embodiment according to FIG. 4. In the first embodiment according to FIG. 4, the arc discharge 50 was assumed to be close enough to the center of the cylinder formed by walls 22. However, as explained above, the arc 50 may instead be positioned off-center. In the configuration according to the first embodiment (FIG. 4) this would lead to degradation of focus, because the light would not be reflected exactly into the arc, leading to a minor image beside the arc of itself. While this may still be acceptable in many applications, the second embodiment proposes a special configuration where an off-center arc 50 is reflected with better focus.

As shown in FIG. 6, and in more detail in the enlarged view of FIG. 6a, the wall 22 of discharge vessel 16 comprises a plurality of plane specially directed surfaces 40, extending in longitudinal direction and positioned alongside each other in the area covered by coating 28. The surfaces 40 are each arranged in a direction facing the center of the actual position of the arc discharge 50, which is different from the center of the cylindrical discharge vessel 16. Thus, light emitted from the center of arc 50 is reflected back at each of the focus surfaces 40 quite exactly to is originating location. Of course, due to the extension of the arc, which emits light not only from its exact center, the reflected image will still be slightly larger than the arc 50 itself. But the loss of focus introduced by the off-center arc 50 will be countered to a certain degree by the accordingly arranged surfaces 40. The surfaces thus form a sort of Fresnel lens, focused to the actual arc position.

It should, of course, be noted, that the shifting of the arc with respect to the centrally arranged electrodes is due to gravity and therefore its direction depends on orientation of lamp 10. However, a lamp will have its recommended orientation for use, which is generally horizontal, and the compensation archived with focus surfaces 40 will correspond to this preferred orientation.

Since ceramic wall 22 may be produced by extrusion, the shape of focus surfaces 40 may be incorporated during production. Of course, in alternative embodiments the focus surfaces 40 need not be plain, but may resemble circle segments etc.

FIG. 7 shows a cross-sectional view through the lamp of FIG. 1 with an outer cylinder 14 and a discharge vessel 16 according to a third embodiment of invention.

Discharge vessel 16 with arc discharge 50 is arranged inside of outer cylinder 14. In contrast to the first and second embodiment above, a reflective coating 28 is not arranged on the discharge vessel 16, but on the inside of outer cylinder 14.

Outer cylinder 14 is, at least in its central portion surrounding the discharge vessel 16, of cylindrical shape and its inner surface 42 has circular cross-section. The walls of cylinder 14 extend straight in longitudinal direction, such that inner surface 42 runs parallel to the central axis of cylinder 14. Thus, reflective coating 28 arranged on the inside of cylinder 14 is focused towards the central axis.

Light emitted from an arc discharge 50 within discharge vessel 16 will therefore be reflected back at reflective coating 28 to its originating position, such that good focus is maintained. If the arc 50 is positioned off-center, for the reasons explained above, there is a certain loss of focus. This might still be acceptable up to a certain level. However, in the embodiments according to FIG. 7 this effect is countered by arranging the discharge vessel 16 itself off-center within the outer cylinder 14, so that the arc 50 ends up again on the central axis, providing good focus.

In addition to or alternatively to the given compensation methods, other measures may be taken to compensate for an off-center arc. For example, comparable to the second embodiment, the outer cylinder may comprise a compensating structure on its inner surface 42 to restore focus to an off-center arc.

The coating 28 provided on the inner surface 42 of outer cylinder 14 may be provided as a dip coating. Possible materials would include Ni—P with a melting point between 600 and 1000° C. depending on phosphor content, and Ni—W, which will resist even higher temperatures.

Here, again care should be taken to avoid voltage breakdown outside of the discharge vessel 16 instead of inside, especially for high voltage ignition peaks in the order of 25 kV. This may be achieved by providing sufficient distance between current wires and a conductive coating, like Ni—P or Ni—W. Preferably, the coating should be non-conducting. If, however, an electrically conducting layer 28 is used in a configuration where the distance may not be enough, a transparent insulating layer 44 may be provided as shown in FIG. 7.

1. Lamp with
a discharge vessel (16) with electrodes (20) arranged at a distance in a longitudinal direction for creating an arc discharge (50), said discharge vessel (16) being configured such that said arc discharge (50) is essentially straight,
and a reflective barrier (28) at least partly surrounding said discharge vessel (16) for reflecting light emitted from said arc discharge (50), where at least a part of said reflective barrier (28) is arranged in said longitudinal direction between said electrodes (50), and where said reflective barrier (28) extends essentially straight in longitudinal direction.

2. Lamp according to claim 1, where
said discharge vessel (16) comprises an inner envelope with a wall (22) extending straight in said longitudinal direction,
where said reflective barrier (28) is a coating on the outside of said inner envelope.

3. Lamp according to claim 2, where
said wall (22) comprises at its outside, at least in the area of said coating (28), a plurality of specially directed surfaces (40), where each specially directed surface (40) is arranged such that light emitted from said arc discharge (50) is reflected back into said arc discharge (50).

4. Lamp according to claim 1, said lamp further comprising
an outer envelope (14) arranged around said discharge vessel (16),
said outer envelope (14) including a wall (22) extending straight in said longitudinal direction,
where said reflective barrier (28) is a coating on an inside surface (42) of said outer envelope (14).

5. Lamp according to claim 4, where
at least a section of said inside surface (42) has circular cross-section,
where said discharge vessel (16) is arranged in said outer envelope (14) such that said arc discharge (50) is arranged in the center of said circle formed by said inside surface (42).

6. Lamp according to claim 2, where
said coating (28) is not conductive or has an insulating covering (44).

7. Lamp according to claim 1, where
a central curved line (C) in longitudinal direction of said arc discharge (50) has a curvature, measured as the distance (d) of the longitudinal center (Pc) of the central line (C) from a line through the points at 5% (P₁) and 95% (P₂) of the electrode distance (EA) on said curved line,
where said curvature is less than 0.1 mm,
preferably less than 0.07 mm.

8. Lamp according to claim 1, where
said discharge vessel (16) comprises an inner envelope consisting of a translucent or transparent ceramics material.

9. Lamp according to claim 1, where
said barrier (28) extends less than 180° in circumferential direction around said discharge vessel,
and preferably extends in an area such that light emitted from the arc discharge (50) in an area of 195° is not shaded.

10. Vehicle headlight comprising
a reflector (62),
and a lamp (10) according to claim 1.
